(19) United States
(12) Patent Application Publication
(10) Pub. No.: US 2026/0307439 A1
(43) Pub. Date: Oct. 8, 2026

(54) Deployable Buoyancy System for a Vehicle

(71) Applicants: Ryan Robinson, Keswick (CA); Shawn Jacobs, Keswick (CA)

(72) Inventors: Ryan Robinson, Keswick (CA); Shawn Jacobs, Keswick (CA)

(21) Appl. No.: 19/172,697

(22) Filed: Apr. 8, 2025

(51) Int. Cl. B60F 3/00

(52) U.S. Cl. CPC B60F 3/0038

(57) ABSTRACT

A deployable buoyancy system for a vehicle is provided. The system includes a foldable panel with a releasable fastening mechanism along its perimeter. In a stowed configuration, the panel is closed along the releasable fastening mechanism. An inflation cell is positioned on the panel's interior side and is connected to a pressurized cartridge. One or more cinch straps with fasteners secure the panel to the vehicle. Upon activation, the cartridge inflates the cell, causing the panel to unfold and break the releasable fastening mechanism, exposing the interior side. In some embodiments, a water-detection sensor automatically triggers inflation upon contact with water. The system can be mounted to the front and/or rear of the vehicle to provide flotation and stability in water environments.

### BACKGROUND OF THE INVENTION

The present invention relates to deployable buoyancy systems, specifically a removable flotation device designed to enhance the buoyancy and stability of all-terrain vehicles (ATVs) when traversing water. More specifically, this invention provides a compact, easily deployable solution that utilizes a foldable panel with an integrated inflation system, allowing the ATV to remain afloat without requiring permanent modifications. Upon activation, the system rapidly inflates, providing immediate buoyant support to prevent sinking and improve stability in aquatic environments.

All-terrain vehicles (ATVs) are commonly used in off-road environments, including areas with water crossings such as rivers, swamps, and flood-prone regions. While ATVs are designed for rugged terrain, they typically lack sufficient buoyancy to remain stable or afloat in deep water, increasing the risk of sinking or loss of control. This limitation poses a safety hazard to riders and can lead to vehicle damage or stranding in hazardous conditions.

Existing solutions for ATV flotation primarily include permanent floatation attachments or emergency flotation devices. However, these options are often bulky, difficult to install, or not easily deployable when needed. Some systems require extensive modifications to the ATV, while others lack sufficient buoyancy or stability.

Accordingly, there is a need for a compact, easily deployable buoyancy system that provides temporary flotation support without permanently altering the vehicle's structure. The present invention addresses this need by providing a lightweight, foldable panel with an integrated inflation system that can be quickly deployed when necessary. The system utilizes a releasable fastening mechanism to keep the panel in a compact, stowed configuration until activation. Upon deployment, a pressurized cartridge inflates an internal bladder, causing the panel to unfold and provide buoyant support. The system is secured to the vehicle using multiple cinch straps with fasteners, ensuring a stable attachment. In some embodiments, a water-detection sensor automatically triggers inflation upon contact with water, further enhancing safety and ease of use. By offering a compact, removable, and rapidly deployable flotation solution, the present invention improves vehicle safety in water environments without requiring permanent modifications to the vehicle.

In light of the devices disclosed in the known art, it is submitted that the present invention substantially diverges in design elements and methods from the known art and consequently it is clear that there is a need in the art for an improvement of a deployable buoyancy system for a vehicle. In this regard the instant invention substantially fulfills these needs.

### SUMMARY OF THE INVENTION

In view of the foregoing disadvantages inherent in the known types of floatation systems for vehicles, the present invention provides an improved deployable buoyancy system that enhances ATV flotation and stability when traversing water.

The present invention is directed toward a system for providing temporary buoyancy support to an ATV using a lightweight, foldable panel with an integrated inflation system. The system comprises a panel having an interior side and an exterior side, a releasable fastening mechanism disposed along the perimeter of the interior side to secure the panel in a stowed configuration, an inflation cell positioned within the panel, and a pressurized CO2 cartridge fluidly connected to the inflation cell. The system further includes one or more cinch straps with fasteners configured to secure the panel to the ATV. Upon activation, the pressurized cartridge releases gas into the inflation cell, causing it to expand and forcing the panel to unfold, thereby breaking the fastening mechanism and transitioning the panel to a deployed configuration that exposes the interior side and provides buoyancy.

One objective of the present invention is to provide a buoyancy system that deploys rapidly and efficiently upon activation, offering immediate flotation support to an ATV in water environments.

Another objective of the deployable buoyancy system is to integrate a releasable fastening mechanism, such as a hook and loop fastener, that securely maintains the panel in a compact stowed configuration until deployment.

A further objective of the deployable buoyancy system is to provide an automatic activation option through a water-detection sensor that triggers inflation upon contact with water. In one embodiment, the sensor includes a dissolvable trigger element that ruptures upon prolonged water exposure, while in another embodiment, an electronic switch sends an activation signal upon detecting water.

An additional objective of the deployable buoyancy system is to provide a secure attachment system using at least four pairs of cinch straps, disposed at fixed intervals on opposing lateral sides of the panel, with cam buckle fasteners to ensure a stable connection to the ATV.

It is an objective of the present invention to provide a buoyancy system constructed from durable, water-resistant materials, including a nylon panel, a thermoplastic polyurethane (TPU) coated nylon fabric inflation cell, and a zinc-coated steel CO₂ cartridge for corrosion resistance. [0013] Another objective is to design the system for flexible mounting to either the front and/or rear of an ATV, ensuring balanced flotation and enhanced stability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of one embodiment of the deployable buoyancy system in an open configuration.

FIG. 2 shows a perspective view of the deployable buoyancy system mounted to an ATV in the stowed configuration.

FIG. 3 shows a perspective view of the deployable buoyancy system mounted to an ATV in the deployed configuration.

### DETAILED DESCRIPTION OF THE INVENTION

Reference is made herein to the attached drawings. Like reference numerals are used throughout the drawings to depict like or similar elements of the deployable buoyancy system. For the purpose of presenting a clear description of the present invention, the preferred embodiment will be discussed in relation to providing flotation and stability to a vehicle in water environments. The figures are intended for representative purposes only and should not be considered limiting in any respect.

As used herein, the term “vehicle” refers to any mode of transportation designed for land, water, or amphibious travel. This includes, but is not limited to, all-terrain vehicles (ATVs), utility task vehicles (UTVs), motorcycles, snowmobiles, personal watercraft, and off-road vehicles. While the present invention is primarily described in the context of ATVs, it is understood that the deployable buoyancy system may be adapted for use with other vehicles requiring temporary flotation support.

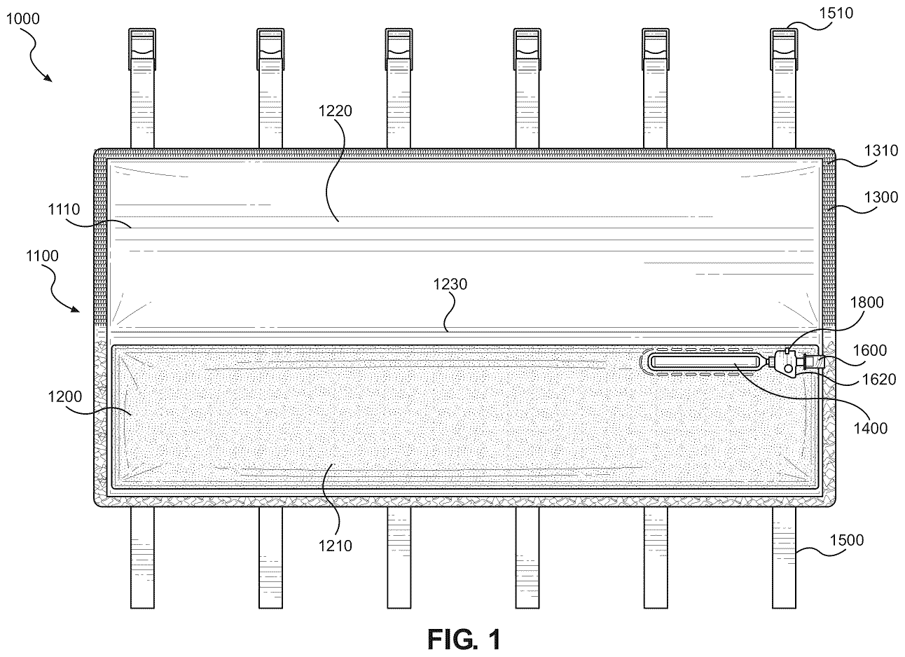

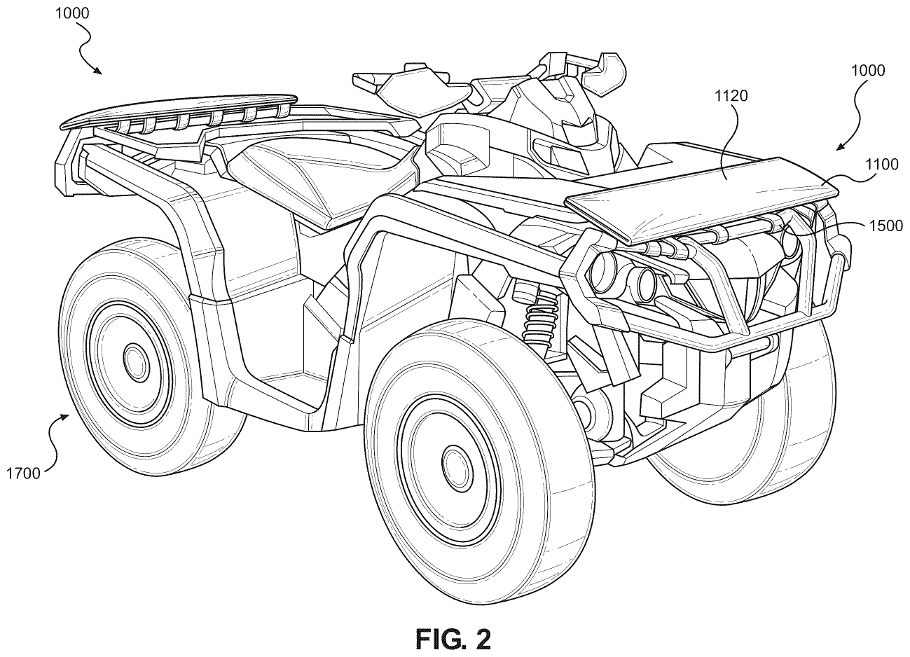

Referring to FIG. 1, there is shown a perspective view of one embodiment of the deployable buoyancy system in an open configuration. The deployable buoyancy system 1000 is designed to provide flotation support to an all-terrain vehicle (ATV) when traversing water. The system transitions between a stowed configuration, where it remains compact and secured, and a deployed configuration, where it expands to provide buoyancy. In the shown embodiment, the system 1000 comprises a panel 1100 having an interior side 1110 opposite an exterior side (shown in FIG. 2). The panel 1100 serves as the structural base for the buoyancy system 1000 and provides a mounting surface for other components. The interior side 1110 comprises an inflation cell 1200, which is positioned on a first portion 1210 of the interior side 1110.

In one embodiment, the first portion 1210 is adjacent to a second portion 1220, with the two portions divided by a fold line 1230. In the stowed configuration, the panel 1100 is folded along the fold line 1230 so that the first portion 1210 and second portion 1220 are positioned against each other.

In the shown embodiment, a releasable fastening mechanism 1300 is disposed along a perimeter 1310 of the interior side 1110 of the panel 1100. The fastening mechanism 1300 is configured to secure the panel 1100 in the stowed configuration by holding the first portion 1210 against the second portion 1220. In one embodiment, the fastening mechanism 1300 comprises a hook and loop fastener 1300 that provides a secure yet breakable seal. This type of fastening mechanism 1300 maintains the system 1000 in a compact, stowed configuration until deployment. The inflation cell 1200 is fluidly connected to a pressurized cartridge 1400, which is configured to release pressurized gas into the inflation cell 1200 upon activation. The pressurized cartridge 1400 serves as the inflation source, allowing for rapid deployment of the buoyancy system 1000 when flotation support is required. Upon activation, the inflation cell 1200 expands, forcing the first portion 1210 and the second portion 1220 apart. This action breaks the releasable fastening mechanism 1300 and transitions the panel 1100 from the stowed configuration to the deployed configuration, in which the panel 1100 is fully opened and the interior side 1110 is exposed.

The system 1000 further includes one or more cinch straps 1500, each having a fastener 1510. The cinch straps 1500 are configured to secure the panel 1100 to a vehicle. The cinch straps 1500 are configured to secure the buoyancy system 1000 to the vehicle during operation. The fasteners 1510 are configured to provide an adjustable and reliable attachment mechanism. In this way, the straps 1500 are adapted to accommodate various vehicle sizes and configurations.

In the stowed configuration of the deployable buoyancy system 1000, the panel is in a compact and unobtrusive form factor. In the stowed configuration, the straps 1500 are easily accessible which allows the panel 1100 to be conveniently mounted without interfering with normal vehicle operation. The deployed configuration, on the other hand, maximizes the exposed surface area of the inflation cell 1200, ensuring optimal buoyancy and stability when the vehicle encounters water. The inflation cell 1200 is sized to provide sufficient buoyant force to keep the vehicle afloat when deployed. In one embodiment, the inflation cell 1200 extends across a substantial portion of the panel 1100. The inflation cell 1200 is configured to evenly weight distribution and stability.

The volume of the inflation cell 1200 is configured to displace a sufficient amount of water to counteract the weight of the vehicle, thereby causing the vehicle to float. By utilizing a properly sized inflation cell 1200, the buoyancy system 1000 prevents the vehicle from submerging while maintaining stability. In some embodiments, multiple inflation cells 1200 may be used to provide additional flotation and balance, particularly for larger or heavier vehicles. In one embodiment, the panel 1100 measures approximately 20 inches by 36 inches, providing an optimal balance between compact storage and effective flotation coverage. In other embodiments, the panel 1100 comprises a size that ranges from 10 inches to 30 inches by 12 inches to 72 inches. The inflation cell 1200 extends across a substantial portion of the panel 1100, ensuring even weight distribution and stability. In one embodiment, the deployable buoyancy system 1000 includes a water-detection sensor 1600, which automatically triggers inflation upon water contact.

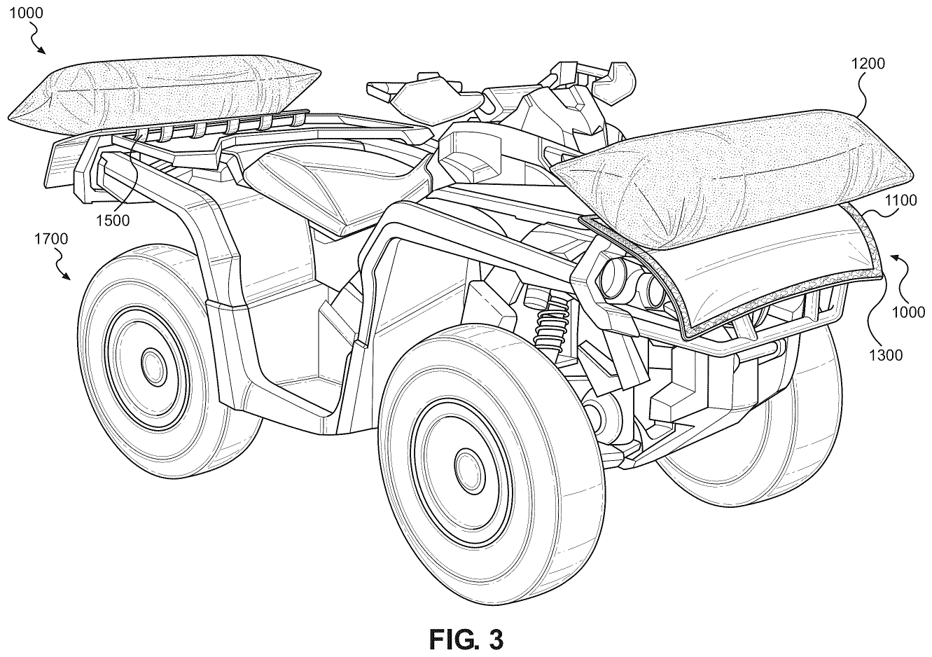

Referring to FIG. 2 and FIG. 3, there are shown a perspective views of one embodiment of the deployable buoyancy system mounted to an ATV in the stowed configuration and in the deployed configuration, respectively. In the shown embodiment, the panel 1100 of the deployable buoyancy system 1000 is secured to the vehicle using one or more cinch straps 1500, each having a fastener 1510. In one embodiment, the cinch straps 1500 include at least four pairs of straps, positioned at fixed intervals along opposing lateral sides of the panel 1100. This provides even weight distribution and secure attachment to the vehicle. In one embodiment, the fasteners of the cinch straps 1500 are cam buckles that are adapted to allow for adjustable tensioning and a firm grip on the vehicle.

In one embodiment, the inflation cell 1200 comprises a single chamber 1260, allowing for uniform inflation across the panel 1100. The single-chamber design ensures even displacement of water, providing consistent buoyancy without creating pressure imbalances. In alternative embodiments, the inflation cell 1200 comprises multiple chambers.

As shown in FIG. 2, the deployable buoyancy system 1000 is in the stowed configuration which is configured to be compact and allows normal vehicle operation without obstruction. The exterior side 1120, opposite the interior side, of the panel 1100 is exposed. In the deployed configuration (FIG. 3), the fully expanded inflation cell 1200 provides sufficient buoyancy to keep the vehicle afloat. The deployable buoyancy system 1000 further includes a release valve 1800 (shown in FIG. 1), which allows the inflation cell 1200 to be deflated after deployment. The release valve 1800 enables controlled air release, facilitating repacking and reuse of the system. In one embodiment, the release valve 1800 is a manually operated push-button valve, while in another embodiment, it includes an automatic pressure relief function to prevent over-inflation.

In one embodiment, the deployable buoyancy system 1000 includes a water-detection sensor 1600, which automatically triggers inflation upon water contact. The water-detection sensor 1600 may include a dissolvable trigger element that ruptures when submerged for a predetermined duration, activating the pressurized cartridge 1400. In another embodiment, the water-detection sensor 1600 comprises an electronic switch 1620 that detects water exposure and sends an activation signal to the pressurized cartridge 1400.

The inflation cell 1200 is sized to provide sufficient buoyant force to keep the vehicle afloat when deployed. In one embodiment, the inflation cell 1200 extends across a substantial portion of the panel 1100 and the dimensions of the inflation cell 1200 are selected based on the anticipated weight and displacement needs of the vehicle. The volume of the inflation cell 1200 is configured to displace a sufficient amount of water to counteract the weight of the vehicle. By utilizing a properly sized inflation cell 1200, the buoyancy system 1000 prevents the vehicle from submerging while maintaining stability. The system is designed to support a range of vehicle weights, with variations in inflation cell 1200 volume available for different applications. In some embodiments, multiple inflation cells 1200 may be used to provide additional flotation and balance, particularly for larger or heavier vehicles.

The deployable buoyancy system 1000 is configured or mounting to either the front, rear, or both portions of the vehicle 1700, depending on the required buoyancy and stability. This flexibility allows users to adjust flotation placement based on environmental conditions and vehicle load distribution. The deployable buoyancy system 1000 offers a lightweight, removable flotation solution that does not require permanent vehicle modifications. By utilizing an automatically expanding inflation cell 1200, a breakable fastening mechanism 1300, and an adjustable cinch strap system 1500, the system ensures a rapid and efficient transition between its two states, providing reliable flotation support when needed.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A deployable buoyancy system for an all-terrain vehicle, comprising:
a panel having an interior side opposite an exterior side;
a releasable fastening mechanism disposed along a perimeter of the interior side of the panel, the releasable fastening mechanism configured to pack and form a stowed configuration;
an inflation cell positioned on a first portion of the interior side of the panel, the first portion being adjacent to a second portion;
one or more of cinch straps each having a fastener, the fastener configured to retain the panel to a vehicle;
a pressurized cartridge fluidly connected to the inflation cell, the pressurized cartridge configured to release pressurized gas into the inflation cell upon activation;
wherein, upon inflation of the inflation cell, the inflation cell expands causing the panel to unpack and breaking the releasable fastening mechanism, thereby transitioning the panel from the stowed configuration to a deployed configuration in which the panel opens and exposes the interior side of the panel.

2. The deployable buoyancy system of claim 1, wherein the releasable fastening mechanism is disposed along a perimeter of the panel.

3. The deployable buoyancy system of claim 2, wherein in the stowed configuration, the panel is folded along a fold line and the panel is coupled via the releasable fastening mechanism.

4. The deployable buoyancy system of claim 2, wherein the first portion and the second portion are divided by the fold line.

5. The deployable buoyancy system of claim 2, wherein the releasable fastening mechanism comprises a hook and loop fastener.

6. The deployable buoyancy system of claim 1, further comprising a water-detection sensor configured to detect water exposure and automatically activate the pressurized cartridge upon contact with water.

7. The deployable buoyancy system of claim 6, wherein the water-detection sensor comprises a dissolvable trigger element that ruptures upon prolonged water exposure, thereby activating the pressurized cartridge.

8. The deployable buoyancy system of claim 6, wherein the water-detection sensor comprises an electronic switch that sends an activation signal to the pressurized cartridge upon detecting water.

9. The deployable buoyancy system of claim 1, wherein the one or more cinch straps comprise at least four pairs of straps disposed at fixed interval on opposing lateral sides of the panel.

10. The deployable buoyancy system of claim 1, wherein the fastener of each cinch strap comprises a cam buckle.

11. The deployable buoyancy system of claim 1, wherein the pressurized cartridge is a CO₂ cartridge.

12. The deployable buoyancy system of claim 1, wherein the inflation cell is made of thermoplastic polyurethane (TPU) coated nylon fabric.

13. The deployable buoyancy system of claim 1, wherein the CO₂ cartridge is constructed from zinc-coated steel.

14. The deployable buoyancy system of claim 1, wherein the panel is configured to be mounted to a front and/or a rear portion of the vehicle.

15. The deployable buoyancy system of claim 1, wherein the inflation cell comprises a single chamber to provide uniform inflation.

16. The deployable buoyancy system of claim 1, further comprising a release valve for deflating the inflation cell after deployment.

17. The deployable buoyancy system of claim 1, wherein the panel is approximately 20 inches by 36 inches.
